(19) United States
(12) Patent Application Publication
(10) Pub. No.: US 2007/0260576 A1
(43) Pub. Date: Nov. 8, 2007

(54) Method of and system for receiving real estate property information using a wireless device

(76) Inventors: Stacy Ellen Elliott, New Canaan, CT (US); Michael Howard, Bellevue, WA (US)

Correspondence Address: WINSTEAD PC, P.O. BOX 50784, DALLAS, TX, 75201, US

(21) Appl. No.: 11/800,720

(22) Filed: May 7, 2007

Related U.S. Application Data
(60) Provisional application No. 60/797,967, filed on May 5, 2006.

(51) Int. Cl. G06F 17/30

(52) U.S. Cl. 707/1

(57) ABSTRACT

A method of accessing data related to real estate property includes obtaining, via a workstation, real estate property information and storing the real estate property information on the first workstation. The method further includes transferring, via a short-range wireless communication link, the real estate property information from the first workstation to a first wireless communication device and transferring, via a short-range wireless communication link, the real estate property information from the first wireless communication device to a second wireless communication device.

### CROSS-REFERENCE TO RELATED APPLICATIONS

This patent application claims priority from, and incorporates by reference the entire disclosure of, U.S. Provisional Patent Application No. 60/797,967, filed on May 5, 2006. This patent application is a continuation of, and incorporates by reference the entire disclosure of, an International Application entitled “METHOD OF AND SYSTEM FOR RECEIVING REAL ESTATE PROPERTY INFORMATION USING A WIRELESS DEVICE”, filed on May 4, 2007 and bearing Attorney Docket No. 47017-P001WO.

### BACKGROUND

1. Field of the Invention

The present invention relates to wireless data transmissions and, more particularly, but not by way of limitation, to a method of and system for accessing and retrieving data related to real estate property using a wireless application protocol (WAP) enabled device such as, for example, a cellular phone, personal digital assistant (PDA), and the like.

2. History of Related Art

Homeowners and homebuyers have long needed an efficient way to discover and evaluate information about real estate service providers. A typical person finds information about the real estate service providers by word of mouth, checking classified advertisements, using Internet search engines, and the like. Once homeowners and homebuyers have identified the real estate service provider, the real estate service provider typically utilizes computerized real estate information databases such as, for example, the multiple listing service (MLS) database to provide or obtain information about properties both listed and sold. The MLS database enjoys widespread acceptance throughout the industry. Access to the MLS database is restricted to licensed real estate professionals, appraisers, and lending institutions.

The MLS typical database contains a set of property listing records describing real estate properties being offered for sale, lease, or rental for a defined geographical region. Each listing typically identifies and describes various characteristics of the property in a standard, pre-defined format that can be easily and accurately searched. Listings can include information related to the real estate properties such as, for example, maps, visual images of the property, pricing, tax information, and the like.

When a real estate property is initially listed for sale, lease, or rent, a sign is often erected on or near the property. The sign may list, for example, a name of the real estate company to which that property is listed as well as a real estate agent of that company. Since many real estate companies have their own website, the prospective buyer can often utilize the Internet to obtain information about the property. However, unless the prospective buyer is in possession of a laptop computer or other device with wireless communication capabilities, the prospective buyer is unable to access the real estate company website in order to obtain additional information about the property.

In addition to finding information of the property on the website, printed materials or flyers may also be placed at a location on the sign. The flyers may contain information related to the real estate property such as, for example, maps, visual images of the property, pricing, and the like. However, the printed materials or flyers often run out and therefore may not be readily available to prospective buyers looking for immediate and comprehensive information regarding the property.

### SUMMARY OF THE INVENTION

A method of accessing data related to real estate property includes obtaining, via a workstation, real estate property information and storing the real estate property information on the first workstation. The method further includes transferring, via a short-range wireless communication link, the real estate property information from the first workstation to a first wireless communication device and transferring, via a short-range wireless communication link, the real estate property information from the first wireless communication device to a second wireless communication device.

A system for accessing data related to real estate property includes a workstation adapted to obtain real estate property information, a first wireless communication device adapted to receive, via a short range wireless communication link, the real estate property information from the workstation, and a second wireless communication device adapted to receive, via a short range wireless communication link, the real estate property information from the first wireless communication device.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a schematic block diagram of a system for inputting information;

FIG. 2 is a schematic block diagram of a system for transferring information according to principles of the present invention;

FIG. 3 illustrates an exemplary sign and a wireless communication device according to principles of the present invention;

FIG. 4 is a schematic block diagram of a structure of a BLUETOOTH wireless communication device;

FIG. 5 illustrates communication between a plurality of communication devices;

FIG. 6 is a block diagram of a system for retrieving real estate property information;

FIG. 7 is a flow diagram for downloading property information on a wireless communication device; and

FIG. 8 is a flow diagram for retrieving property information on a personal wireless communication device of a prospective buyer.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein; rather, the embodiments are provided so that this disclosure will be thorough and complete, and will fully convey the scope of the invention to those skilled in the art.

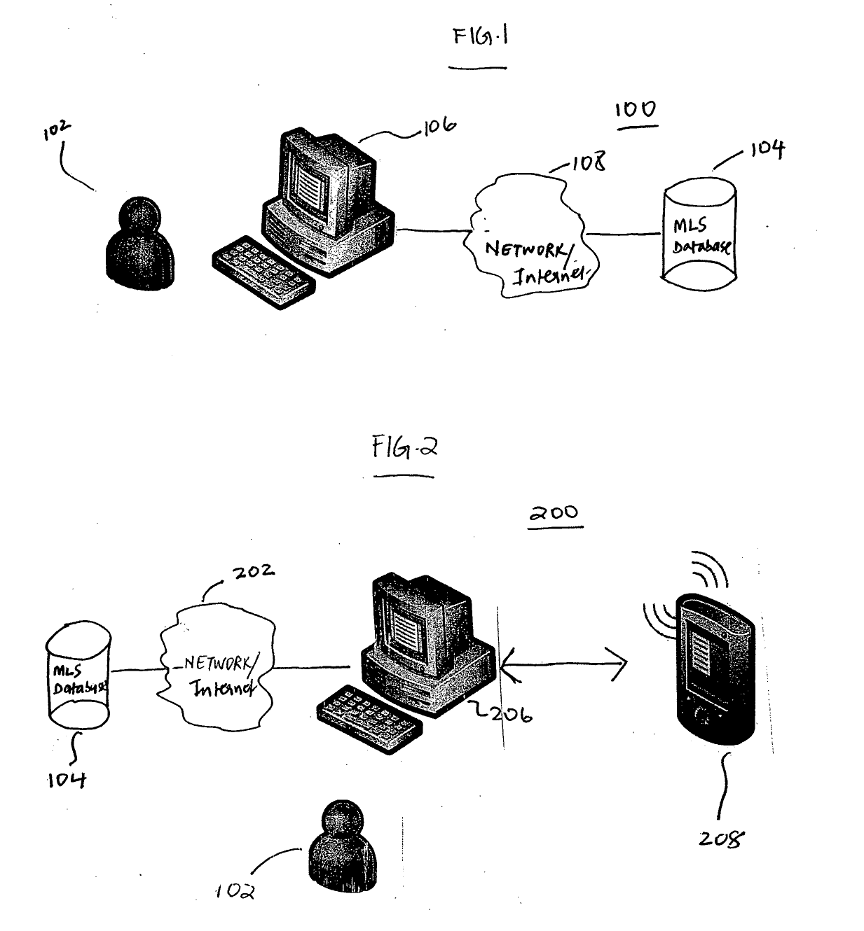

Once homeowners and homebuyers have identified a particular real estate service provider, the real estate service provider may utilize computerized real estate information databases such as, for example, multiple listing service (MLS) database to provide/or obtain information about properties both listed and sold. FIG. 1 is a schematic block diagram of a system 100 for inputting information by a real estate agent 102 into the MLS database 104. A real estate agent 102 may be, for example, an individual real estate agent or a real estate agent affiliated with a real estate company. The system 100 includes a workstation 106. In the illustrated embodiment, the system 100 includes one workstation 106; however, any number of workstations may be included within the system 100. The MLS database 104 may be remote from the workstation 106 and may be connected to the workstation 106 via, for example, the Internet 108. The workstation 106 may be, for example, a server computer, a personal computer (PC), a mainframe computer, or the like.

Once the real estate agent 102 receives property information from the owner, the real estate agent 102 enters the property information into the MLS database 104 via the workstation 106. The property information entered into the MLS database 104 may be, for example, sale and/or lease information, location information, visual images of the property, school districts, pricing, tax information, and the like. The MLS database 104 is adapted to provide information about properties both listed and sold. Access to the MLS database 104 is typically restricted to licensed real estate professionals, appraisers, and lending institutions.

FIG. 2 is a schematic block diagram of a system 200 for transferring information from the MLS database 104 to a wireless communication device 208. In various exemplary embodiments, the wireless communication device 208 is, for example, a BLUETOOTH-enabled wireless communication device. The wireless communication device 208 may be a BLUETOOTH transceiver or a BLUETOOTH transmitter with a port (e.g., a USB or FIWIRE interface) to receive information via a cable. In other embodiments, the wireless communication device 208 may receive information via insertion of a memory card or the like and be adapted to transmit data wirelessly via, for example, the BLUETOOTH standard. Those having skill in the art will appreciate that the BLUETOOTH standard is not the only wireless technology that may be employed in connection with various embodiments of the invention. Rather, any wireless technology that is capable of transmitting data wirelessly over short distances may be employed without departing from principles of the invention.

The system 200 includes a workstation 206. In the illustrated embodiment, the system 200 includes one workstation 206; however, any number of workstations may be included within the system 200. The MLS database 104 may be remote from the workstation 206 and may be connected to the workstation 206 via, for example, the Internet 202.

A real estate agent 102 having proper credentials to access the MLS database 104 typically accesses the MLS database 104 via the workstation 206 and retrieves the information of a particular property for lease and/or sale. The property information retrieved from the MLS database 104 may be, for example, sale and/or lease information, location information, visual images of the property, school districts, pricing, tax information, and the like.

The property information retrieved from the MLS database 104 may be stored on the workstation 206. The workstation 206 may be, for example, a server computer, a personal computer (PC), a mainframe computer, or the like. In an exemplary embodiment, the property information is transferred from the workstation 206 to the wireless communication device 208 wirelessly via BLUETOOTH wireless technology. Once the property information is transferred from the workstation 206 to the wireless communication device 208, the property information is stored in a memory within the wireless communication device 208. A software code adapted to provide an interface between the wireless communication device 208 and the property information stored on the workstation 206 may be employed. The workstation 206 and the wireless communication device 208 are each typically equipped to support BLUETOOTH wireless communications.

BLUETOOTH wireless technology is adapted to provide communication between devices without the presence of connection cables that often exist between various communication devices. BLUETOOTH wireless technology is a widely adopted standard for ad-hoc networks that may be established between the various communication devices using a radio link in the 2.4 GHz band. BLUETOOTH wireless technology supports wireless communications at relatively short distances between the various communication devices and, in a typical implementation, provides a synchronous connection-oriented (SCO) link and an asynchronous connectionless link (ACL). Devices that can be connected to each other using the BLUETOOTH wireless technology include desktop/notebook computers, mobile communication terminals, mobile phones, and other portable communication equipment.

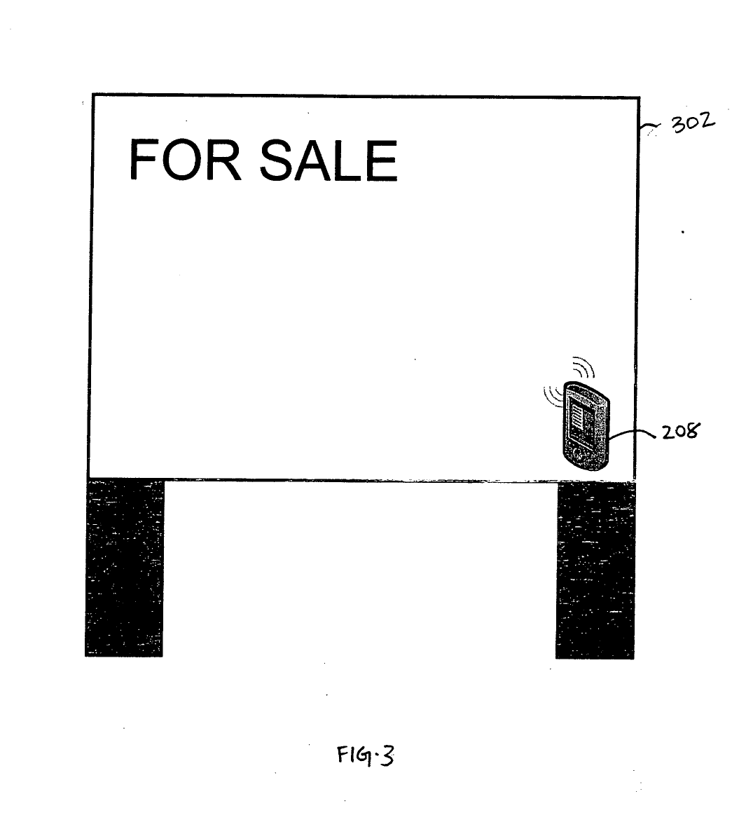

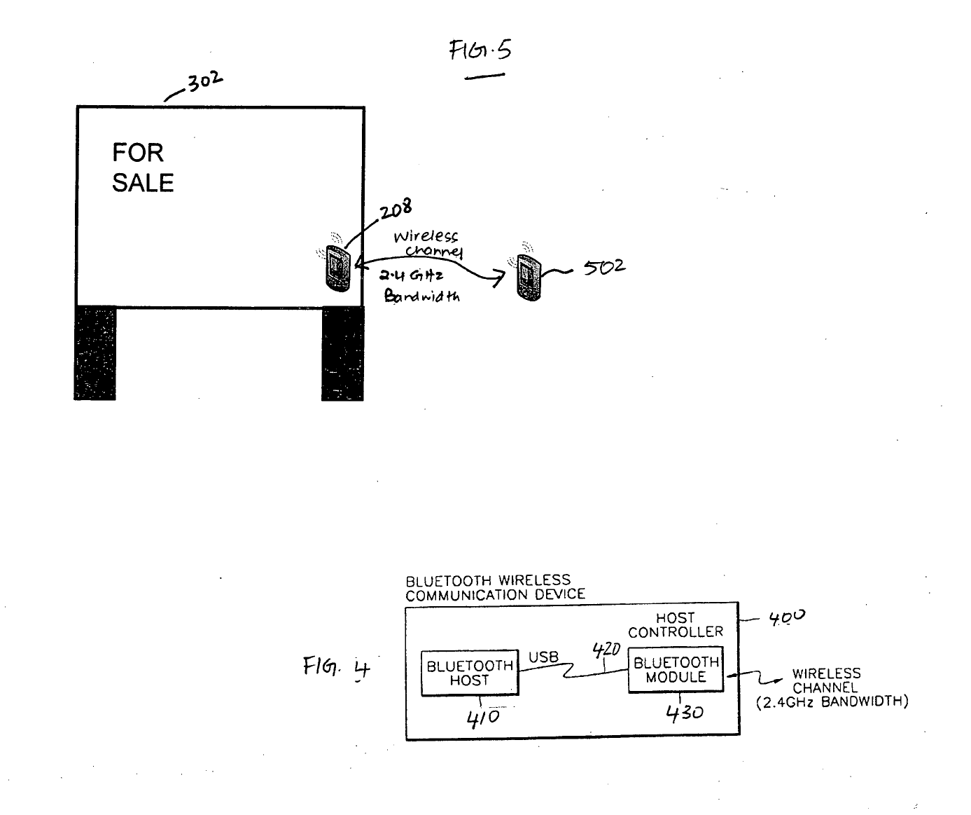

FIG. 3 illustrates an exemplary sign 302 that may be erected on or near the property listed for sale, rent, or lease. In the context of the patent application, the term “near the property” also refers to the sign being erected on the property. The sign 302 is illustrated with a wireless communication device 208 attached thereto. After the property information has been transferred from the workstation 206 to the wireless communication device 208, the wireless communication device 208 may be attached to the sign and the sign erected on or near the property listed for sale, lease, or rent. The sign 302 may list, for example, a name of the real estate company with which that property is listed as well as the real estate agent 102 of the listing real estate company. The sign 302 may also include, for example, a mark notifying a prospective buyer that the property information is available via a personal wireless communication device.

The wireless communication device 208 eliminates the need for printed materials and flyers containing information of the property. A prospective buyer needing information regarding the property may obtain the property information from the wireless communication device 208 via a personal wireless communication device, for example, via BLUETOOTH wireless technology.

Those having skill in the art will appreciate that the wireless communication device 208 need not necessarily be physically attached to the sign 302. Rather, the wireless communication device 208 should be located sufficiently close to an area in which prospective customers are expected to view the sign 302 so that wireless communications may be had between the wireless communication device 208 and the prospective customers.

FIG. 4 is a schematic block diagram of a structure of a typical BLUETOOTH wireless communication device 400. As shown in FIG. 4, a portion of the wireless communication device 400 that performs wireless communication with external devices is referred to as a BLUETOOTH module 430 (e.g., a host controller). A BLUETOOTH host 410 processes data transferred and received through the BLUETOOTH module 430. The BLUETOOTH module 430 transfers data to and receives data from an external device through a wireless channel. The BLUETOOTH host 410 transfers data received from an application to the BLUETOOTH module 430, reads data received from the BLUETOOTH module 430, and transfers the received data to the application. A portion of the wireless communication device 400 that defines an interface between the BLUETOOTH host 410 and the BLUETOOTH module 430 is referred to as a host controller interface (HCI), the HCI not being explicitly shown. In the HCI, a universal serial bus (USB) 420, a PC card, RS232, a universal asynchronous receiver/transmitter (UART), or other interfaces can be used.

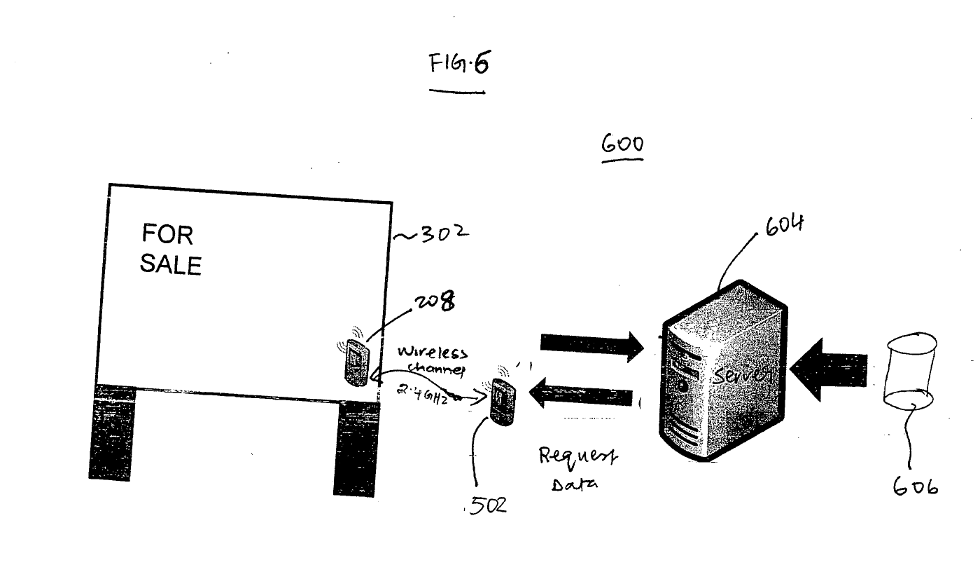

FIG. 5 illustrates communication between a plurality of wireless communication devices. The sign 302 includes the wireless communication device 208. After the property information has been transferred from the workstation 206 to the wireless communication device 208, the wireless communication device 208 may be placed on or near the sign 302. As noted above, the sign 302 is typically erected on or near a property listed for sale, lease, or rent. The property information on the wireless communication device 208 may be, for example, sale and/or lease information, location information, visual images of the property, school districts, pricing, tax information, and the like.

In an exemplary embodiment, a prospective buyer needing information regarding the property may download the property information from the wireless communication device 208 onto their personal wireless communication device 502 via BLUETOOTH wireless technology. In some embodiments, the wireless communication device 208 may be adapted to receive information via BLUETOOTH or another wireless technology from the prospective buyer. For example, the prospective buyer could send contact information to the wireless communication device 208, ask questions about the property being listed, or provide other information to the wireless communication device 208, for example, for later use by a listing real estate agent.

In order for the prospective buyer to download property information from the wireless communication device 208 onto their personal wireless communication device 502, the prospective buyer is typically required to enter a software code on their personal wireless communication device 502. In an exemplary embodiment, the software code may be, for example, downloaded from a real estate company website by the prospective buyer. The prospective buyer in some embodiments brings the personal wireless communication device 508 within effective range of BLUETOOTH devices (e.g., 32 feet or 10 meters) of the wireless communication device 208 in order to pair the wireless communication devices 208 and 502. BLUETOOTH pairing occurs when the wireless communication devices 208 and 502 agree to communicate with one another. Once paired, the wireless communication devices 208 and 502 become a trusted pair. When the wireless communication device 208 recognizes the wireless communication device 502, each of the wireless communication devices 208 and 502 automatically accepts communication, bypassing the discovery and authentication process. During the communication process, property information is transferred from the wireless communication device 208 to the wireless communication device 502. Thus, the prospective buyer can view the property information on the wireless communication device 502 without having to read a flyer or other printed material. In an exemplary embodiment, the information transferred from the wireless communication device 208 to the wireless communication device 502 may include property information that may be, for example, rental and/or sale information including price, property dimensions, number of rooms, number of bathrooms, real estate agent contact information, visual images of the property, and a web link to view further details of the property.

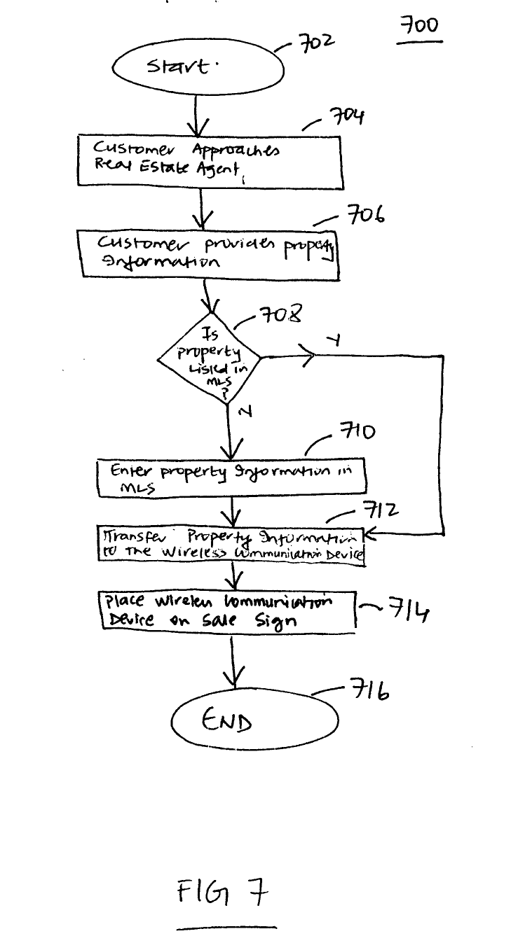

FIG. 6 is a block diagram of a system 600 for retrieving real estate property information. The system 600 includes a sign 302 erected on or near the property listed for sale, rent, or lease. The sign 302 includes a wireless communication device 208 having the property information stored thereon. The system 302 further includes a personal wireless communication device 502 carried by a prospective buyer. In an exemplary embodiment, a prospective buyer needing information regarding the property may download the property information from the wireless communication device 208 onto their personal wireless communication device 502. The information transferred from the wireless communication device 208 to the wireless communication device 502 may include property information which may be, for example, rental and/or sale information including price, property dimensions, number of rooms, number of bathrooms, real estate agent contact information, images of the property, and a web link to view further details of the property.

The prospective buyer may also use a web browser on the personal wireless communication device 502 to access a web server 604 if the device 502 is so equipped. The web server 604 is connected to a database 606 that maintains detailed information regarding the property. The detailed property information may be transferred via the server 604 to the prospective buyer's personal wireless communication device 502. Viewing property information on the personal wireless communication device 502 allows the prospective buyer to obtain immediate and comprehensive information about the property.

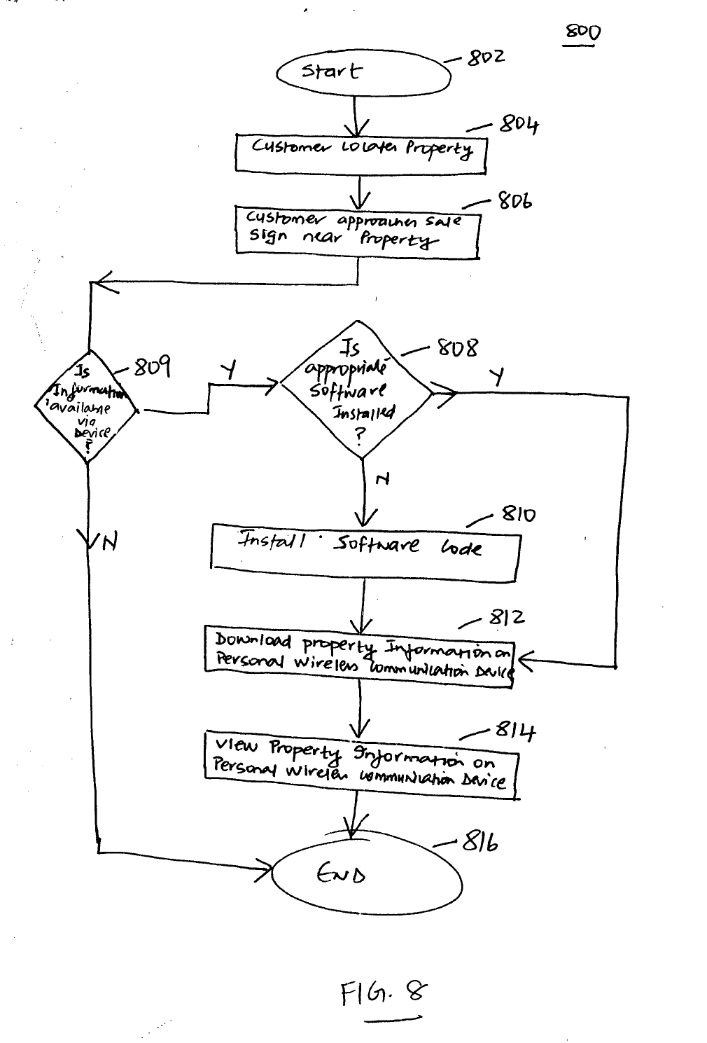

FIG. 7 is a flow diagram illustrating a process for downloading property information on a wireless communication device 208 adapted to be placed on a sign 302 erected near a property listed for sale, lease, or rent. A flow 700 starts at step 702. At step 704, a customer approaches the real estate agent 102. In an exemplary embodiment, the customer may be, for example, a prospective buyer or seller of a property. At step 706, the customer provides property information to the real estate agent. The information provided by the customer may include, for example, sale and/or lease information, location information, visual images of the property, school districts, pricing, tax information, and the like. At step 708, the real estate agent 102 determines if the property information is already listed in the MLS database 104. If it is determined at step 708 that the property information is not listed in the MLS database 104, the process 700 proceeds to step 710. At step 710, the real estate agent 102 enters the property information in the MLS database 104. From step 710, the process 700 proceeds to step 712. If it is determined at step 708 that the property information is listed in the MLS database 104, the process proceeds to step 712.

At step 712, the property information is transferred to the wireless communication device 208. In an exemplary embodiment, the property information is transferred from the workstation 206 utilized by the real estate agent 102 to the wireless communication device 208 wirelessly via BLUETOOTH wireless technology. Once the property information is transferred from the workstation 206 to the wireless communication device 208, the property information is stored in a memory within the wireless communication device 208. At step 714, the wireless communication device 208 having the property information stored thereon is placed on the sign 302 erected on or near the property listed for sale, rent, or lease. The process ends at step 716.

Those having skill in the art will appreciate that, although the process 700 and other aspects of various embodiments of the invention have been described herein as utilizing BLUETOOTH wireless technology, other wireless technologies may be used without departing from principles of the invention. Moreover, although the MLS system and MLS databases are described for convenience in this patent application, the invention should not be considered so limited. Other databases and informational systems may be utilized to store information regarding properties without departing from principles of the invention.

FIG. 8 is a flow diagram illustrating a process for retrieving property information on a personal wireless communication device 502 of a customer. A process 800 starts at step 802. At step 804, a customer locates a property for sale. In an exemplary embodiment, the customer may be, for example, a prospective buyer of the property or an individual interested in leasing and/or renting the property. At step 806, the customer approaches a sign 302 erected near the property. At step 809, the customer determines if the property information is obtainable via the personal wireless communication device 502. The personal wireless communication device 502 may be, for example, a BLUETOOTH-enabled cellular phone, a BLUETOOTH-enabled personal digital assistant (PDA), and the like. If it is determined at step 809 that the property information is not available via the personal wireless communication device 502, the process 800 ends at step 816. However, if it is determined at step 809 that the property information is available via the personal wireless communication device 502, the process 800 proceeds to step 808.

At step 808, it is determined whether a software code is already on the wireless communication device 502. If it is determined at step 808 that the software code is not already installed on the customer's wireless communication device 502, the process 800 proceeds to step 810. At step 810, the software code is entered into the customer's wireless communication device 502. After entering the software code, the process 800 proceeds to step 812. If it is determined at step 808 that the software code is already installed on the customer's wireless communication device 502, the process 800 proceeds to step 812.

At step 812, the property information is transferred from the wireless communication device 208 placed on the sign 302 to the personal wireless communication device 502. At step 814, the customer uses the personal wireless communication device 502 to access the property information. The process 800 ends at step 816.

The previous detailed Description is of embodiment(s) of the invention. The scope of the invention is instead defined by the following claims and the equivalents thereof.

What is claimed is:

1. A method of accessing data related to real estate property, the method comprising:
obtaining, via a workstation, real estate property information;
storing the real estate property information on the first workstation;
transferring, via a short-range wireless communication link, the real estate property information from the first workstation to a first wireless communication device; and
transferring, via a short-range wireless communication link, the real estate property information from the first wireless communication device to a second wireless communication device.

2. The method according to claim 1, further comprising the step of providing access, via the second wireless communication device, to the real estate property information.

3. The method according to claim 2, wherein the step of providing access comprises playing a video of the real estate property.

4. The method according to claim 1, wherein the second wireless communication device comprises a BLUETOOTH enabled device owned by a prospective buyer or lessee of the real estate property.

5. The method according to claim 1, wherein the real estate property information comprises:
sales information;
lease information;
location information;
visual views;
school district information;
tax information; and
an Internet address.

6. The method according to claim 1, wherein the workstation, the first wireless communication device, and the second wireless communication device each comprise a BLUETOOTH module.

7. The method according to claim 1, wherein the second wireless communication device is a BLUETOOTH enabled cellular phone.

8. The method according to claim 1, wherein the second wireless communication device is a BLUETOOTH enabled personal digital assistant (PDA).

9. The method according to claim 1, wherein the first wireless communication device is attached to a sign erected near the real estate property.

10. The method according to claim 1, wherein the first wireless communication device is a BLUETOOTH transceiver.

11. The method according to claim 1, wherein the first wireless communication device comprises a BLUETOOTH transmitter and a port adapted to receive the real estate property information via a cable.

12. The method according to claim 1, wherein the real estate property information is obtained from a structured real estate property database.

13. The method according to claim 1, wherein the short-range wireless communication link is in a 2.4 GHz band.

14. A system for accessing data related to real estate property, the system comprising:
a workstation adapted to obtain real estate property information;
a first wireless communication device adapted to receive, via a short range wireless communication link, the real estate property information from the workstation; and
a second wireless communication device adapted to receive, via a short range wireless communication link, the real estate property information from the first wireless communication device.

15. The system according to claim 14, wherein the second wireless communication device comprises a BLUETOOTH enabled device owned by a prospective buyer or lessee of the real estate property.

16. The system according to claim 14, wherein the real estate property information comprises:
sales information;
lease information;
location information;
visual views;
school district information;
tax information; and
an Internet address.

17. The system according to claim 14, wherein the workstation, the first wireless communication device, and the second wireless communication device each comprise a BLUETOOTH module.

18. The system according to claim 14, wherein the second wireless communication device is a BLUETOOTH enabled cellular phone.

19. The system according to claim 14, wherein the second wireless communication device is a BLUETOOTH enabled personal digital assistant (PDA).

20. The system according to claim 14, wherein the first wireless communication device is attached to a sign erected near the real estate property.

21. The system according to claim 14, wherein the first wireless communication device is a BLUETOOTH transceiver.

22. The system according to claim 14, wherein the first wireless communication device comprises a BLUETOOTH transmitter and a port adapted to receive the real estate property information via a cable.

23. The system according to claim 14, wherein the real estate property information is obtained from a structured real estate property database.

24. The system according to claim 14, wherein the short-range wireless communication link is in a 2.4 GHz band.
